(19) United States
(12) Patent Application Publication
(10) Pub. No.: US 2018/0375913 A1
(43) Pub. Date: Dec. 27, 2018

(54) SYSTEM AND METHOD FOR MANAGEMENT OF CONTENT PRESENTATION WITHIN A USER INTERFACE

(71) Applicant: Facebook, Inc., Menlo Park, CA (US)

(72) Inventors: Brian Paihan Sa, Mountain View, CA (US); Khalid M. Ashour, San Francisco, CA (US); Nikola Vilimonovic, San Francisco, CA (US); Xingdi Li, Mountain View, CA (US); Syed Faisal Karim, Menlo Park, CA (US); Mason Daniel Silber, New York, NY (US)

(21) Appl. No.: 15/632,178

(22) Filed: Jun. 23, 2017

(51) Int. Cl. H04L 29/06; G06F 3/048; H04W 72/12; G06Q 50/00

(52) U.S. Cl. CPC H04L 65/604; G06Q 50/01; H04W 72/1242; G06F 3/048

(57) ABSTRACT

Methods, systems, computer-readable media, and apparatuses for management of content presentation within a user interface are presented. Certain embodiments are described that allow for the management of content presentation within a user interface. A channel management subsystem may manage the presentation of content to a user from one or more channels within the social network. The channel management subsystem may receive requests from one or more channels to present content to a user within a user interface (UI) of the social network. The channel management subsystem may grant or deny the received requests based on various rules or criteria. The channel management subsystem may help ensure that the user of the social network is not overwhelmed by the presentation of inorganic content or sponsored content within the UI of the social network.

### BACKGROUND

A user of a system may be presented with various types of content within a user interface. For example, within a social network, a user may be presented with content via a user interface associated with the social network, such as (1) content generated by other users of the social network, (2) content generated by the host or server of the social network, (3) content generated by third-parties associated with the social network, etc. These various types of content may be organic content (e.g., content generated by other users of the social network) or inorganic content (e.g., content generated by the host or server of the social network) or sponsored content.

Often times, a user of the social network may be presented with inorganic content or sponsored content, and the user may become frustrated with the user experience of the social network, because their experience with the social network may seem too heavily defined by the host or server of the social network rather than by the user's friends or connections within the social network. As a result, the user may be less inclined to continue using the social network.

Accordingly, a need exists for the management of content presentation within a user interface.

### BRIEF SUMMARY

Certain embodiments are described that allow for the management of content presentation within a user interface. A channel management subsystem may manage the presentation of content to a user from one or more channels within the social network. A channel may be any content source within the social network. The channel management subsystem may receive requests from one or more channels to present content to a user within a user interface (UI) of the social network. The channel management subsystem may grant or deny the received requests based on various rules or based on outputs of machine learning models. The channel management subsystem may help ensure that the user of the social network is not overwhelmed by the presentation of inorganic content (e.g., content generated by the host or server of the social network as opposed to content generated by other users) or sponsored content within the UI of the social network.

In some embodiments, a method may include, within a social network system comprising one or more channels of content, receiving, from a first channel, a first request to present content via a first content unit within a user interface (UI) being presented to a user. The method may also include determining whether content has been presented to the user within a predetermined window of time prior to a present time. The method may further include in response to determining that content has not been presented to the user within the predetermined window of time, determining whether a second request from a second channel to present content via a second content unit within the UI is pending, otherwise denying the received first request to present the content. The method may additionally include in response to determining that the second request is not pending from the second channel to present content via the second content unit within the UI, granting the first request to present the content via the first content unit within the UI, otherwise granting either the first request or the second request based on an order of priority between the first channel and the second channel.

In some embodiments, the order of priority between the first channel and the second channel is determined by assigning a higher priority to the first channel if a number of previously granted requests for the first channel is less than a number of previously granted requests for the second channel, otherwise assigning a higher priority to the second channel.

In some embodiments, the order of priority between the first channel and the second channel is determined by comparing a priority number associated with the first channel to a priority number associated with the second channel.

In some embodiments, the order of priority between the first channel and the second channel is determined based on an output from a classifier, wherein the classifier is trained using data associated with prior engagements by the user with content, and wherein the classifier receives as inputs data pertaining to the user and the content.

In some embodiments, the method may also include receiving, from an urgent channel, an urgent request to present content within the UI and granting the received urgent request to present the content within the UI irrespective of whether content has been presented to the user within the predetermined window of time prior to the present time.

In some embodiments, the method may also include assigning a slot within the predetermined window of time to the first content unit.

In some embodiments, the method may also include determining whether another one of the one or more channels of content that has a higher priority than the first channel has content available to present via another content unit within the UI and reassigning the slot within the predetermined window of time to the other content unit.

In some embodiments, the method may also include determining whether the one or more channels of content have content available to present within the UI to the user.

In some embodiments, the method may also include upon an event wherein the UI being presented to the user is refreshed, receiving a request from one of the one or more channels to present content within the UI, wherein another one of the one or more channels has been presenting content within the UI prior to the UI being refreshed; determining whether the other one of the one or more channels has been presenting content within the UI for a period of time exceeding the predetermined window of time; and in response to determining that the other one of the one or more channels has been presenting content within the UI for a period of time exceeding the predetermined window of time, granting the request from the one of one or more channels to present content within the UI, otherwise denying the request.

In some embodiments, the content is system-generated content.

In some embodiments, a system may include a processor and a non-transitory computer readable medium coupled the processor, the computer readable medium comprising code, executable by the processor, for implementing a method. The method may include, within a social network system comprising one or more channels of content, receiving, from a first channel, a first request to present content via a first content unit within a user interface (UI) being presented to a user. The method may also include determining whether content has been presented to the user within a predetermined window of time prior to a present time. The method may additionally include in response to determining that content has not been presented to the user within the predetermined window of time, determining whether a second request from a second channel to present content via a second content unit within the UI is pending, otherwise denying the received first request to present the content. The method may further include in response to determining that the second request is not pending from the second channel to present content via the second content unit within the UI, granting the first request to present the content via the first content unit within the UI, otherwise granting either the first request or the second request based on an order of priority between the first channel and the second channel.

In some embodiments, one or more non-transitory computer-readable media store computer-executable instructions that, when executed, cause one or more computing devices to within a social network system comprising one or more channels of content, receive, from a first channel, a first request to present content via a first content unit within a user interface (UI) being presented to a user; determine whether content has been presented to the user within a predetermined window of time prior to a present time; in response to determining that content has not been presented to the user within the predetermined window of time, determine whether a second request from a second channel to present content via a second content unit within the UI is pending, otherwise deny the received first request to present the content; and in response to determining that the second request is not pending from the second channel to present content via the second content unit within the UI, grant the first request to present the content via the first content unit within the UI, otherwise grant either the first request or the second request based on an order of priority between the first channel and the second channel.

### BRIEF DESCRIPTION OF THE DRAWINGS

Aspects of the disclosure are illustrated by way of example. In the accompanying figures, like reference numbers indicate similar elements, and ***.

FIG. 1 illustrates a simplified diagram of a communication device and server computer that may incorporate one or more embodiments;

FIG. 2 illustrates an exemplary user interface for a social network client application displayed on a display of a communication device, in accordance with some embodiments;

FIG. 3 illustrates an exemplary flowchart for a process of managing content presentation within a user interface, in accordance with some embodiments;

FIG. 4 illustrates a flowchart for an exemplary process of determining an order of priority between a first channel and a second channel, in accordance with some embodiments;

FIG. 5 illustrates a simplified diagram of a communication device and server computer, where the social network client application includes a local channel, in accordance with some embodiments;

FIG. 6 illustrates a flowchart 600 for an exemplary process of managing content presentation within a user interface where the content is cached, in accordance with some embodiments; and

FIG. 7 illustrates an example of a computing system in which one or more embodiments may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

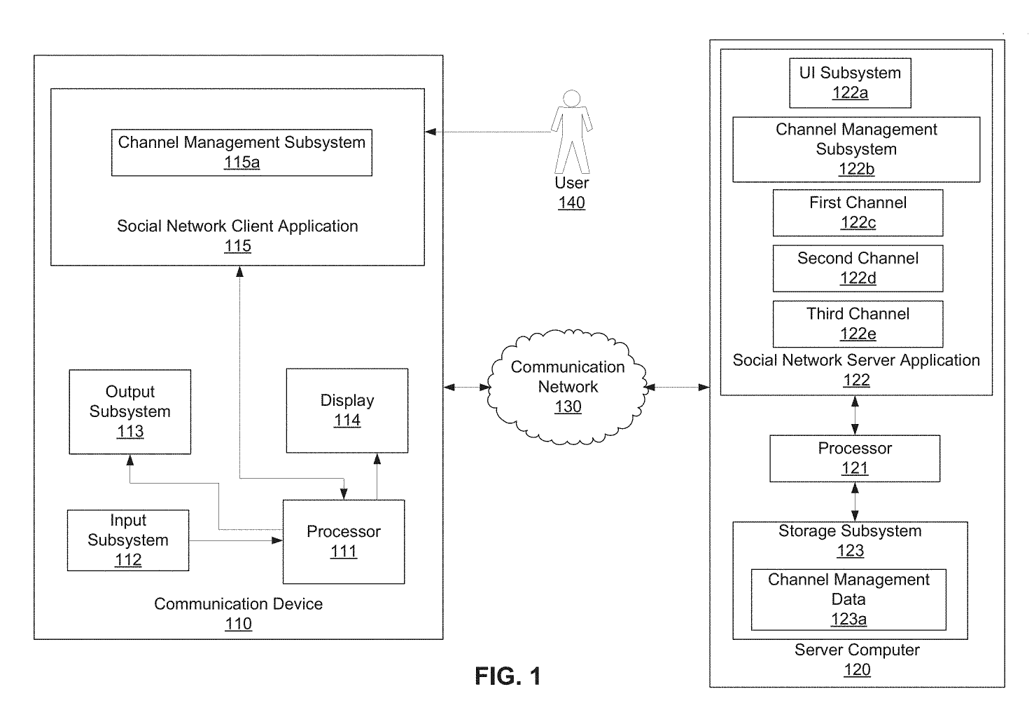

FIG. 1 illustrates a simplified diagram of a communication device 110 and server computer 120 that may incorporate one or more embodiments. The communication device 110 and server computer 120 may communicate with each other via communication network 130. One example of communication network 130 is the Internet.

The communication device 110 may include processor 111, input subsystem 112, output subsystem 113, display 114 and social network client application 115. The communication device 110 may be any type of device capable of communicating with the server computer 120 via the communication network 130. For example, communication device 110 may be a mobile device, tablet computer, personal computer, smartwatch, smart television, wearable device, etc.

Processor 111 may be any general-purpose processor operable to carry out instructions on the communication device 110. The processor may be coupled to input subsystem 112, output subsystem 113, display 114 and social network client application 115. The processor 111 may execute the various applications and subsystems that are part of the communication device 110.

Input subsystem 112 may be configured to receive data from an external device or a user. For example, input subsystem 112 may receive data from server computer 120 via communication network 130. In another example, input subsystem 112 may receive input from the user 140.

Output subsystem 113 may be configured to output or transmit data to an external device or apparatus. For example, output subsystem 113 may transmit data from communication device 110 to server computer 120 via communication network 130. Output subsystem 113 may also transmit (via processor 111) data to display 114, where the data is meant to be presented to user 140. For example, output subsystem 113 may present content from one or more channels to the user 140 via a user interface.

Display 114 may be any device that displays information to a user. Examples may include an LCD screen, LED screen, OLED screen, CRT monitor, etc. In some embodiments, display 114 may be a touchscreen display capable of receiving user input for interaction with the social network client application 115.

Social network client application 115 may be configured to, when executed by the processor 111, allow the user 140 to access a social network via communication device 110. For example, a user may choose to launch the social network client application 115 by selecting an icon associated with the application via input subsystem 112. The social network client application 115 may communicate with the server computer 120, via communication network 130, in order to access the social network. The server computer 120 may grant the user access to the social network via the social network server application 122. The user may use input subsystem 112 to interact with various elements within the social network client application 115. Examples of a social network client application 115 include, but is not limited to, a web browser, a mobile application, etc.

The social network client application may also include channel management subsystem 115a. Channel management subsystem 115a may be configured to, when executed by processor 111, interact with channel management subsystem 122b on server computer 120 in order to facilitate management of presentation of content within the UI of the social network. The functions of channel management subsystem 115a are described in further detail below.

The server computer 120 may include social network server application 122 and storage subsystem 123, which both may be coupled to a processor 121. The processor 121 may execute the various applications and subsystems that are part of the server computer 120, such as the social network server application 122.

Social network server application 122 may be configured to, when executed by processor 121, allow users to participate in a social networking community in which users network through friends, friends of friends, and so forth. A user may create a personal profile. The user can browse and search through all of the users connected to a user through networks of friends or view profiles associated with businesses, establishments, places, etc. A user can also view photos and profiles, see how the user is connected to other users, send messages, ask friends for introductions, or suggest matches between friends or even friends of friends. The social network application can be used for all types of social networking. A user 140 may access the social network via the communication device 110 (e.g., personal computer, smartphone, tablet, etc.) executing the social network client application 115 which accesses and interfaces with the social networking server application 122 on the server computer 120.

The social network server application 122 may include a UI subsystem 122a, channel management subsystem 122b, first channel 122c, second channel 122d, and third channel 122e.

The UI subsystem 122a may be configured to, when executed by processor 121, generate or facilitate the generation of a user interface for the social network. The generated user interface may then be presented to the user 140 via the display 114 of the communication device 110. The generated user interface may include content from one or more channels of content. A channel of content may be a source of content that can be presented to a user of the social network via the generated user interface. In some embodiments, different channels of content may be placed in different locations within the generated user interface. In this example, the social network server application may include a first channel 122c, a second channel 122d, and a third channel 122e. Each channel may provide content for presentation to the user which may be presented within a content unit displayed within the user interface. For example, the first channel 122c may provide “urgent” or “emergency” for presentation to the user. The channels and the content provided by the channels may be generated by the host or server of the social network server application. The content may be displayed within a content unit that is displayed to the user by the social network client application 115, via the display 114, on the communication device 110. In another example, the second channel 122d may provide basketball game score content via a sports ticker content unit, which may be displayed within the generated user interface. It can be appreciated that while three channels are depicted in FIG. 1, any number of channels may be present within the social network server application 122.

The channel management subsystem 122b may be configured to, when executed by the processor 121, receive requests from one or more channels (e.g., first channel 122c, second channel 122d, and third channel 122e) to present content via content units within the user interface being presented to the user. Upon receiving the requests, the channel management subsystem 122b may determine whether to grant or deny the requests based upon various criteria, such that content provided by the one or more channels is provided in a fashion so as not to overwhelm the user with content (e.g., so that content provided by the channels it not displayed to the user so often that the user's experience with the social network is diminished). The channel management subsystem 122b on the server computer 120 may interface with the channel management subsystem 115a to accomplish the management of presentation of content from the one or more channels described above. The functionality of the channel management subsystem 122b is described in further detail below.

Storage subsystem 123 may be configured to store data. In one example, the storage subsystem 123 may store channel management data 123a. The channel management data 123a may be data pertaining to the one or more channels within social network server application 122. The data pertaining to the one or more channels may include a priority number for each channel, historical presentation times for each channel (e.g., previous times at which content was presented by the channel), current presentation times for each channel (e.g., how long content provided by a channel for display has been displaying), user interaction data for each channel (e.g., user tendencies and frequencies for interacting with each channel), or any other data used by the channel management subsystem 122b for the management of presentation of content within the UI of the social network.

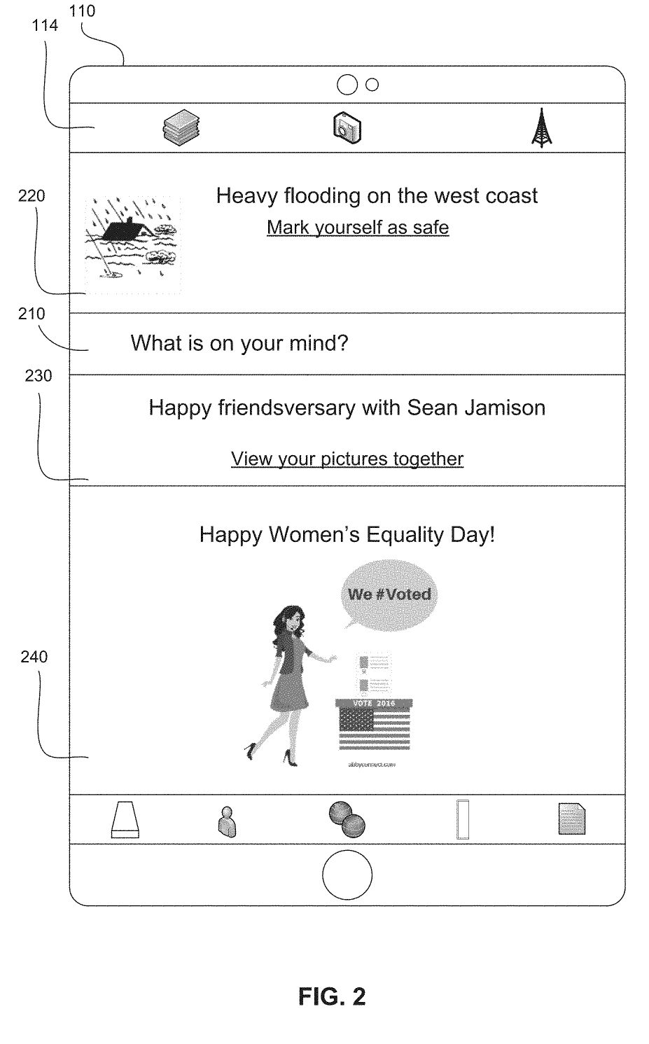

The following example illustrates how the communication device 110 and server computer 120 may interact with each other in order to implement the management of presentation of content within the UI of the social network described above. A user may launch the social network client application 115 on the communication device 110 in order to interact with the social network. The user may be presented with various content from the user's friends, organizations followed by the user, etc. At some point in time, the channel management subsystem 122b may receive a request from the first channel 122c to present content via a first content unit (described in further detail with respect to FIG. 2) within the UI being presented to the user by the social network client application 115. The content requested to be presented by the first channel 122c may be generated by the host, system, or server of the social network.

The channel management subsystem 122b may then determine whether content, from any channel within the social network server application 122, has been presented to the user within a predetermined window of time prior to the present time. For example, the channel management subsystem 122b may determine whether content, from any channel within the social network server application 122, has been presented to the user within the past fifteen minutes.

If the channel management subsystem 122b determines that content, from any channel within the social network server application 122, has been presented to the user within the predetermined window of time prior to the present time, the channel management subsystem 122b may deny the request from the first channel 122c to present content. This may be so that the user 140 does not become overwhelmed with content generated by the system, server, or host of the social network due to being presented more than one content unit within a fifteen minute window. While this example uses a fifteen minute window as the predetermined window of time, any period of time may be used as the predetermined window of time based on the particular implementation of the channel management subsystem 122b by the social network server application 122. Otherwise, if the channel management subsystem 122b determines that content, from any channel within the social network server application 122, has not been presented to the user within the predetermined window of time prior to the present time, the channel management subsystem 122b may determine whether a second request from another channel (e.g., the second channel 122d or the third channel 122e) is pending. In other words, the channel management subsystem 122b may determine whether more than one channel is requesting to present content to the user 140.

If the channel management subsystem 122b determines that a second request from another channel (e.g., the second channel 122d or the third channel 122e) is not pending, the channel management subsystem 122b may grant the request received from the first channel to present content via the first content unit within the UI to the user. Otherwise, if the channel management subsystem 122b determines that a second request from another channel is pending, the channel management subsystem 122b may grant either the first request or the second request from the other channel based on an order of priority between the first channel and the second channel. Determination of the order of priority between multiple channels is discussed in further detail below.

FIG. 2 illustrates an exemplary user interface for a social network client application 115 displayed on a display 114 of a communication device 110, in accordance with some embodiments. The user interface for the social network client application 115 shows various content presented to a user of the communication device 110. Additionally, the user interface may present the user with a composer prompt 210 which the user may input text into to upload content to the social network.

The various content presented to the user of the communication device 110 may be presented within various content units shown within the user interface. For example, as illustrated, content may be presented to the user via a first content unit 220, a second content unit 230, or a third content unit 240. Content units may be generated by the social network server application 122. The content units may serve as units within the user interface configured to display content and content may be presented to the user of the social network within the content units. The content units may present content from provided by a channel (e.g., first channel 122c, second channel 122d, or third channel 122e).

In this example, the first content unit 220 presents content regarding “Heavy flooding on the west coast” and presents the user with an option to mark himself/herself as being safe. This content may be considered urgent content since it deals with a natural disaster and the personal safety of users of the social network. In some embodiments, urgent content may be provided by a channel regarded as an urgent channel. The urgent channel may provide urgent content for presentation to the user that is considered of utmost importance. Accordingly, if an urgent channel requests the channel management subsystem 122b for permission to provide content for presentation to the user, the channel management subsystem 122b may grant the received request irrespective of whether content has been presented to the user within a predetermined window of time prior to the present time and irrespective of any channel priorities. In some embodiments, a content unit which presents content from an urgent channel may be positioned within the user interface such that it is prominently displayed to the user. For example, the first content unit 220 may be positioned above the composer prompt 210 within the user of the social network client application 115.

In another example, the second content unit 230 may include content for presentation to the user related to a “friendsversary” with the user of the social network's friend, where the user may celebrate the date that the user became friends on the social network with the user's friend. For example, the second content unit 230 may present content to the user that states “Happy friendsversary with Sean Jamison” and provide the user with an option to view the user's pictures together with Sean stored on the social network.

In yet another example, the third content unit 240 may include content about women's equality data. The user may be presented with an image related to voting and a message wishing the user a happy women's equality day.

The examples above illustrate the various content that can be presented within the content units displayed within the user interface of the social network on the display 114 of the communication device 110. The content provided by the channels and presented within the content units may be presented in any other locations within the user interface, and the locations within the example illustrated by the figure are purely exemplary. Additionally, while the example illustrates multiple items of content within multiple content units, it can be appreciated that not all content units may be displayed concurrently in accordance with the presentation rules discussed with respect to FIG. 1 and in further detail below.

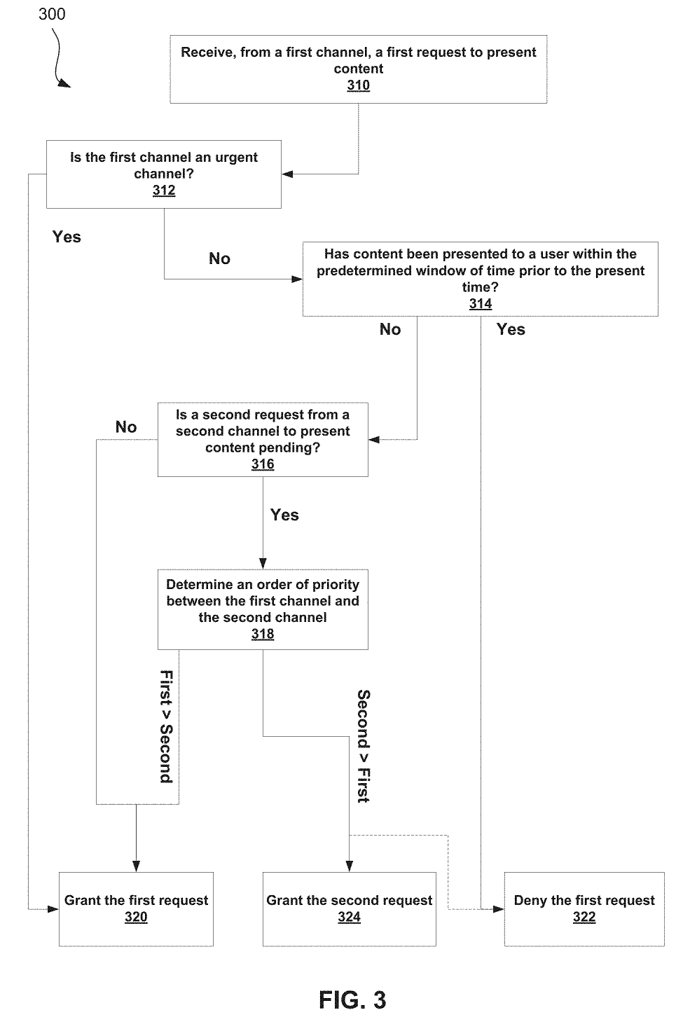

FIG. 3 illustrates a flowchart 300 for an exemplary process of managing content presentation within a user interface, in accordance with some embodiments. At block 310, the channel management subsystem 122b may receive, from a first channel, a first request to present content. For example, the channel management subsystem 122b may receive the request from the first channel 122c. The channel management subsystem 122b may also receive the request from the second channel 122d or the third channel 122e.

At block 312, after receiving the first request from the first channel, the channel management subsystem 122b may determine whether the first channel is an urgent channel. An urgent channel may be a channel that requests the channel management subsystem 122b to present urgent content to the user within a content unit via the user interface of the social network client application 115. An example of urgent content may be safety check content, similar to the example provided with respect to FIG. 2, where the user is presented with content and an associate prompt to mark himself/herself safe during a natural disaster. If the channel management subsystem 122b determines that the request received in block 310 originated from an urgent channel, the process may jump to block 320 and the channel management subsystem 122b may immediate grant the request from the urgent channel to present the content within the UI irrespective of whether content has been presented to the user within the predetermined window of time prior to the present time. For example, if the first channel is an urgent channel, the channel management subsystem 122b may immediately grant the request from the first channel to present the content. If the channel management subsystem 122b determines that the first channel is not an urgent channel, the process may continue to block 314.

At block 314, if the channel management subsystem 122b determines that the first channel is not an urgent channel, the channel management subsystem 122b may determine whether content has been presented to the user within a predetermined window of time prior to the present time. In some embodiments, the predetermined period of time may be fifteen minutes. For example, the channel management subsystem 122b may determine whether content, from any channel, has been presented to the user of the social network within the past fifteen minutes. If the channel management subsystem 122b determines that content has been presented to the user within the predetermined window of time prior to the present time (e.g., the past fifteen minutes), the process may continue to block 322 and the channel management subsystem 122b may deny the first request from the first channel to present the content. This may be so that the user does not become frustrated with the social network user experience by being presented with system-generated content too often.

At block 316, if the channel management subsystem 122b determines that content has not been presented to the user within the predetermined window of time prior to the present time, the channel management subsystem 122b may determine whether a second request, from a second channel, to present content is pending. For example, the channel management subsystem 122b may determine whether a second request from either the second channel 122d or third channel 122e is pending. If the channel management subsystem 122b determines that a second request, from a second channel, to present content is not pending, the process may continue to block 320 and the channel management subsystem 122b may grant the first request received from the first channel to present the content.

In some embodiments, a channel may require an asynchronous call, either to the server computer 120 or locally to the communication device 110, to determine whether the channel has content pending to display. There may be a small time delay between when the asynchronous call was made and when a response to the asynchronous call is received. The channel may send a message to the channel subsystem 122b signifying that the channel requires an asynchronous call. In response, the channel subsystem 122b may grant a provisional assign a slot to the channel that prevents other channels from being granted that slow until the channel placing the asynchronous call has received a response from the server computer 120 or the communication device 110. If the server computer 120 or communication device 110 replies to the asynchronous call and indicates that the channel has content pending, the channel subsystem 122b may upgrade the provisionally assigned slot to a “regular” or “standard” slot. Otherwise, the channel management subsystem 122b may release the provisionally assigned slot so that other channels may be granted the slot. Additionally, the channel management subsystem 122b may also release the provisionally assigned slot if the channel does not receive a response or reply from the server computer 120 or communication device 110 within a predetermined allotted period of time.

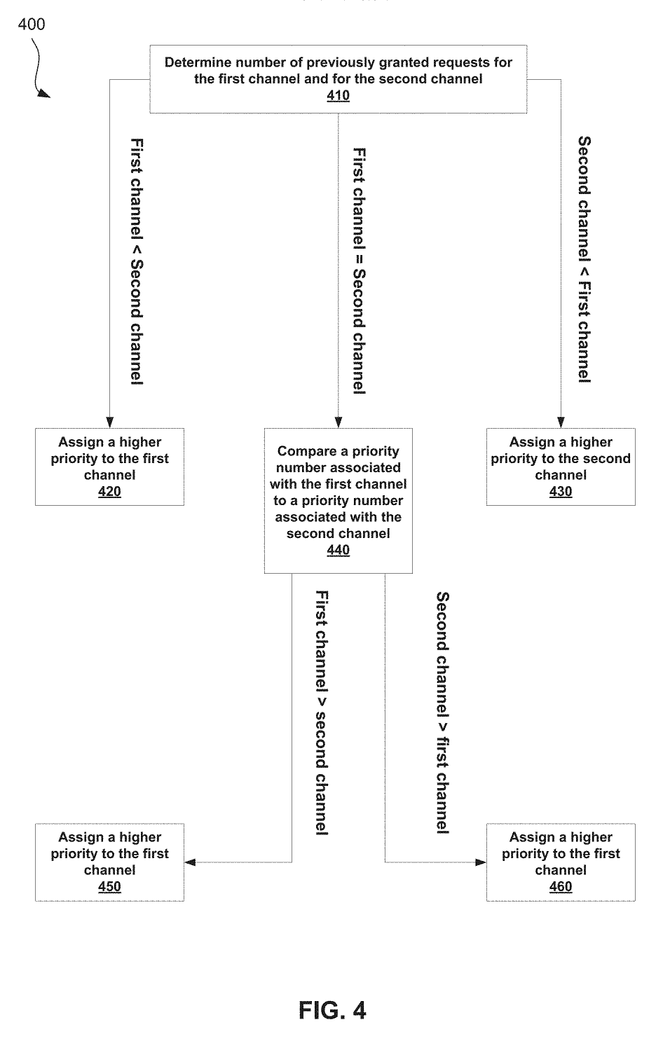

At block 318, if the channel management subsystem 122b determines that a second request, from a second channel, to present content is pending, the channel management subsystem 122b may determine an order of priority between the first channel and the second channel. The process of how the order of priority between the first channel and the second channel is determined is described in further detail with respect to FIG. 4. If the channel management subsystem 122b determines that the first channel has a higher priority than the second channel, the process may continue to block 320 and the channel management subsystem 122b may grant the request received from the first channel to present content. If the channel management subsystem 122b determines that the second channel has a higher priority than the first channel, the process may continue to block 324 and the channel management subsystem 122b may grant the second request, from the second channel, to present content. The channel management subsystem 122b may also deny the first request (block 322) when granting the second request. It can be appreciated that while block 318 illustrates determining an order of priority between two channels, an order of priority between n channels may also be determined. This may be accomplished by generating a sorted list of channels in order of priority. The sorted list may then be iteratively checked by the channel management subsystem 122b to determine whether the next highest priority channel within the sorted list has content available for presentation.

At block 320, the channel management subsystem 122b my grant the first request from the first channel as described above. In some embodiments, upon granting the first request from the first channel, the channel management subsystem 122b may also assign a slot within the predetermined period of time to the first content unit in which content from the first channel is presented to the user. By assigning a slot within the predetermined period of time, no other content unit (with the exception of content units presenting content from an urgent channel) may present content from another channel while the first content unit is in possession of the slot. Similarly, if the process in flowchart 300 ends at block 324, where the second request from the second channel is granted, the slot may be assigned to the second content unit in which content from the second channel is presented to the user. Accordingly, the slot may be assigned to the content unit for the channel having the highest priority in accordance with the process outlined in flowchart 300. In some embodiments, the slot assignment may expire upon the expiration of some predetermined period of time (e.g., 1 minute). That is, if the content unit that the slot is assigned to does not present content from the associated channel up expiration of the predetermined period of time (e.g., 1 minute), the slot may be reassigned to another content unit so that content from another channel may be presented and underutilization of the slot may be prevented.

FIG. 4 illustrates a flowchart 400 for an exemplary process of determining an order of priority between a first channel and a second channel, in accordance with some embodiments. As described above with respect to block 318, if the channel management subsystem 122b determines that a second request, from a second channel, to present content is pending, the channel management subsystem 122b may determine an order of priority between the first channel and the second channel. The process of determining the order of priority between the first channel and the second channel is described below.

At block 410, the channel management subsystem 122b may determine a number of previously granted requests for the first channel and a number of previously granted requests from the second channel. This information may be retrieved, for example, by the channel management subsystem 122b and from the channel management data 123a stored on the storage subsystem 123 within the server computer 120. In some embodiments, the number of previously granted requests for each of the channels may be determined over a certain time period. For example, the channel management subsystem 122b may determine the number of previously granted requests over the last 24 hours, etc. If the channel management subsystem 122b determines that the number of previously granted requests for the first channel is less than the number of previously granted requests for the second channel, the process may continue to block 420. If the channel management subsystem 122b determines that the number of previously granted requests for the second channel is less than the number of previously granted requests for the first channel, the process may continue to block 430. If the channel management subsystem 122b determines that the number of previously granted requests for the first channel is equal to the number of previously granted requests for the second channel, the process may continue to block 440.

At block 420, if the channel management subsystem 122b determines that the number of previously granted requests for the first channel is less than the second channel, the channel management subsystem 122b may assign a higher priority to the first channel. By assigning a higher priority to the channel having a fewer number of previously granted requests, “starvation” of the channel may be prevented. In other words, the channel that has had fewer opportunities to provide content to be displayed within a content unit within the user interface may be given the present opportunity to provide content. In such a way, one channel may not dominate the opportunity to provide content to be presented to the user.

Similarly, at block 430, if the channel management subsystem 122b determines that the number of previously granted requests for the second channel is less than the first channel, the channel management subsystem 122b may assign a higher priority to the second channel.

At block 440, if the channel management subsystem 122b determines that a the number of previously granted requests for the first channel is equal to the number of previously granted requests for the second channel, the channel management subsystem 122b may compare a priority number associated with the first channel to a priority number associated with the second channel. The priority number associated with each channel may be predetermined by an administrator associated with the server computer 120. In some embodiments, the priority number assigned to each channel may be determined based on an output from a classifier. For example, the classifier may be trained using features such as data associated with prior engagements by the user with content provided by each channel. The data associated with prior engagements by the user with content provided by each channel may be stored within the channel management data 123a within the storage subsystem 123 on the server computer 120. For example, the data associated with prior engagements by the user with content provided by each channel may include whether or not the user actively engaged with the content, the length of time that the user engaged with the content, the user's preference with particular types of content over other types of content, etc. During the inference phase, the classifier may be configured to output a class indicative of the user's likelihood to engage with content provided by a particular channel. For example, the classifier may output a yes class or a no class that indicates whether the user is likely to engage with the content provided by a particular channel or not. The output of the classifier may then be used by the channel management subsystem 122b to generate a priority number for the comparison in block 440. For example, higher priority numbers may be generated when the classifier outputs a yes class, and lower priority numbers may be generated when the classifier outputs a low class.

After the channel management subsystem 122b compares the priority number associated with the first channel to a priority number associated with the second channel in block 440, the channel management subsystem 122b may assign a higher priority to the appropriate channel based on the priority number. For example, if the first channel has a higher priority number than the second channel, the channel management subsystem 122b may assign a higher priority to the first channel in block 450. Similarly, if the second channel has a higher priority number than the first channel, the channel management subsystem 122b may assign a higher priority to the second channel in block 460.

In some embodiments, a particular channel may have a priority override assigned to it. For example, a priority override flag may be associated with a particular channel. The priority override may be assigned either by the clash management subsystem 122b or by an administrator of the system. A channel with a priority override flag may be treated as having the highest priority by the channel management subsystem 122b, irrespective of any priority number. If multiple channels have a priority override assigned, a priority order may be pre-determined by an administrator of the system and the priority order may be used by the channel management subsystem 122b to determine the order of priority between the multiple channels having priority override flags assigned to them.

Referring back to FIG. 3, after the priority is assigned to the appropriate channel, the first request from the first channel or the second request from the second channel may be granted in either block 320 or block 324, respectively.

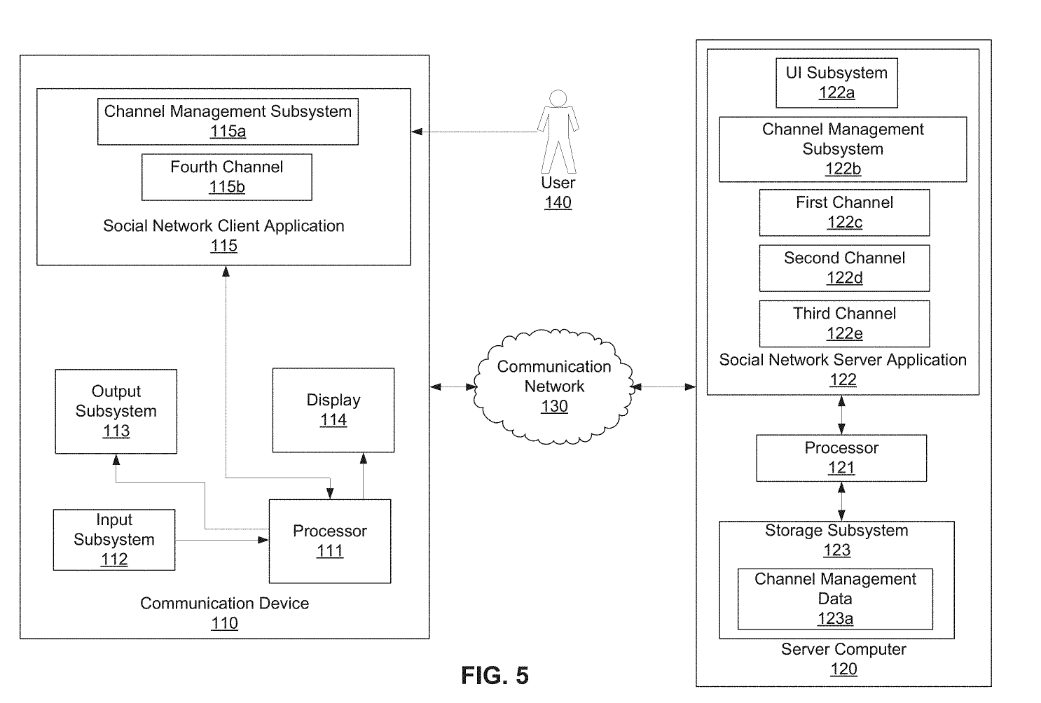

FIG. 5 illustrates a simplified diagram of a communication device 110 and server computer 120, where the social network client application 115 includes a local channel, in accordance with some embodiments. FIG. 5 is similar to FIG. 1, with the difference being that the social network client application 115 on the communication device 110 includes a fourth channel 115b. The fourth channel 115b is local to the social network client application 115 on the communication device, as opposed to being a part of the social network server application 122.

The social network client application 115 may include one or more local channels for a number of reasons, one such reason being able to provide sensitive content within the UI to the user locally without having to send or retrieve data from the server computer 120. For example, if the user 140 of the communication device 110 has recently captured photographs with the communication device 110, the fourth channel 115b may provide content in the form of a prompt displayed within a content unit that asks the user 140 whether he/she wishes to upload the recently captured photographs to the social network via the social network client application 115. A local channel may provide this content in the form of a prompt to the user 140 because it may not be desirable to notify the server computer 120 that the user has recently captured photographs, for privacy reasons.

The channel management subsystem 115a on the social network client application 115 may receive a request from the fourth channel 115b to display local content via a content unit. The channel management subsystem 115a on the social network client application 115 may go through the process of determining whether the fourth channel's 115b request should be granted based using the similar considerations described with respect to FIG. 3. In other words, the channel management subsystem 115a on the social network client application 115 may determine that no other local channel within the social network client application 115 currently deserves the right to provide content over the requesting fourth channel 115b. The channel management subsystem 115a on the social network client application 115 may then provisionally assign a slot within the predetermined period of time to the fourth channel 115b.

However, the provisional assignment of the slot may expire after a short amount of time (e.g., 1 min) if the fourth channel 115b does not actually provide any content for presentation to the user via the content unit. If the provisional assignment of the slot to the fourth channel 115b expires, the channel management subsystem 115a on the social network client application 115 may release the slot assignment and control of slot assignment may return to the channel management subsystem 122b on the social network server application 122. However, if the fourth channel 115b does provide content within the short amount of time (e.g., 1 minute), the channel management subsystem 115a on the social network client application 115 may upgrade the provisional slot assignment into a regular slot assignment and the fourth channel 115b may occupy the slot for the entire predetermined period of time (e.g., 15 minutes). Upon the expiration of the predetermined period of time (e.g., 15 minutes), the slot assignment and control of slot assignment may return to the channel management subsystem 122b on the social network server application 122.

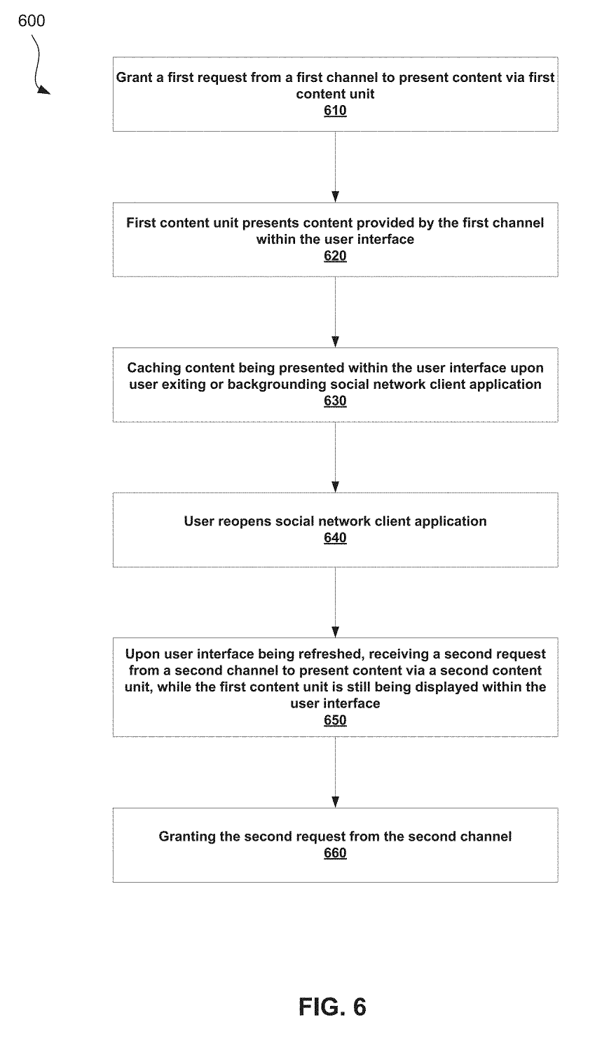

FIG. 6 illustrates a flowchart 600 for an exemplary process of managing content presentation within a user interface where the content is cached, in accordance with some embodiments. In certain instances, a channel may have provided content and that content may be displayed within the user interface of the social network client application 115 and to the user 140. At some point during presentation of the content, the user may exit or background the social network client application 115 on the communication device. However, for increased efficiency and bandwidth optimization, the social network client application 115 may cache all content currently being presented to the user 140 within the social network so that when the user opens or executes the social network client application 115, the cached content will be displayed to the user within the user interface, rather than fetching new data and content from the social network server application 122.

At block 610, the channel management subsystem 122b may grant a first request from a first channel to present content via a first content unit. The decision to grant the request may be in accordance with any of the processes described above.

At block 620, after the channel management subsystem 122b grants the first request from the first channel to present content within the user interface via a first content unit, the first content unit may present the content provided by the first channel within the user interface.

At block 630, after the first content units presents content provided by the first channel within the user interface, the user 140 may exit or background the social network client application 115 on the communication device 110 for any reason, as described above. Upon exiting the app, the social network client application 115 may cache all content currently being presented to the user 140 within the social network so that when the user opens or executes the social network client application 115, the cached content will be displayed to the user within the user interface, rather than fetching new data and content from the social network server application 122. The cached content may include the content being presented by the first content and provided by the first channel within the user interface.

At block 640, after the user 140 exits or backgrounds the social network client application 115 on the communication device 110, the user may reopen or execute the social network client application 115 on the communication device 110. Because the content being presented within the user interface prior to the user exiting or backgrounding the social network client application 115 was cached in block 630, the content being presented by the first content unit may still continue to be presented within the user interface to the user, irrespective of whether or not the predetermined period of time (e.g., 15 minutes) has passed.

At block 650, after the user reopens or executes the social network client application 115 on the communication device 110, the user interface may be refreshed at some point. For example, the user interface may be refreshed thirty seconds after the social network client application 115 is reopened and the user realized that the he has already seen the cached content prior to closing the social network client application. A slot for presentation may still belong to the first content unit even though the user interface has been refreshed. However, the channel management subsystem 122b has knowledge that the first content unit is now a “stale content unit” by virtue of having been presented within the user interface prior to the social network client application 115 having been exited in block 630. A request from another channel to present content via another content unit may be granted by the channel management subsystem 122b if the currently displayed content unit is a stale content unit. For example, the channel management subsystem 122b may receive a second request from a second channel to present content via a second content unit within the user interface. Since the first content unit is now a stale content unit, the channel management subsystem 122b may grant the second request from the second channel to present content via the second content unit, and the slot for presentation may be assigned to the second content unit (block 660).

Implementing the process in flowchart 600 may prevent stale content units from unnecessarily being assigned a slot for presentation for an excessively long period of time due to the interruption of the predetermined period of time by virtue of the user exiting or background the social network client application 115.

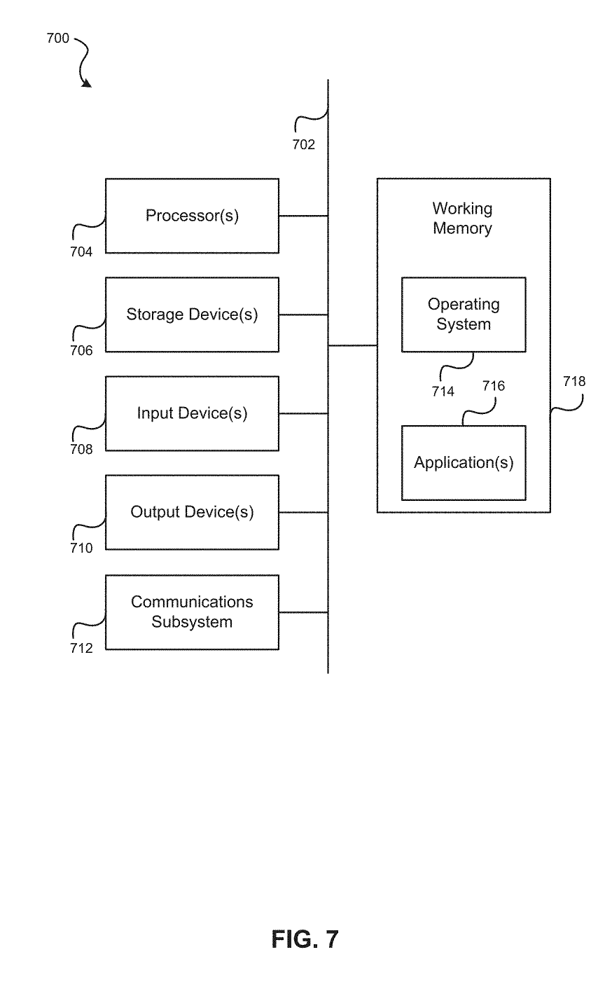

FIG. 7 illustrates an example of a computing system in which one or more embodiments may be implemented. A computer system as illustrated in FIG. 7 may be incorporated as part of the above described computerized device. For example, computer system 700 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 7 provides a schematic illustration of one embodiment of a computer system 700 that can perform the methods provided by various other embodiments, as described herein, and/or can function as the host computer system, a remote kiosk/terminal, a point-of-sale device, a telephonic or navigation or multimedia interface in an automobile, a computing device, a set-top box, a table computer and/or a computer system. FIG. 7 is meant only to provide a generalized illustration of various components, any or all of which may be utilized as appropriate. FIG. 7, therefore, broadly illustrates how individual system elements may be implemented in a relatively separated or relatively more integrated manner. In some embodiments, elements computer system 700 may be used to implement functionality of communication device 110 or server computer 120 in FIG. 1.

The computer system 700 is shown comprising hardware elements that can be electrically coupled via a bus 702 (or may otherwise be in communication, as appropriate). The hardware elements may include one or more processors 704, including without limitation one or more general-purpose processors and/or one or more special-purpose processors (such as digital signal processing chips, graphics acceleration processors, and/or the like); one or more input devices 708, which can include without limitation one or more cameras, sensors, a mouse, a keyboard, a microphone configured to detect ultrasound or other sounds, and/or the like; and one or more output devices 710, which can include without limitation a display unit such as the device used in embodiments of the invention, a printer and/or the like.

In some implementations of the embodiments of the invention, various input devices 708 and output devices 710 may be embedded into interfaces such as display devices, tables, floors, walls, and window screens. Furthermore, input devices 708 and output devices 710 coupled to the processors may form multi-dimensional tracking systems.

The computer system 700 may further include (and/or be in communication with) one or more non-transitory storage devices 706, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 700 might also include a communications subsystem 712, which can include without limitation a modem, a network card (wireless or wired), an infrared communication device, a wireless communication device and/or chipset (such as a Bluetooth™ device, an 802.11 device, a Wi-Fi device, a WiMax device, cellular communication facilities, etc.), and/or the like. The communications subsystem 712 may permit data to be exchanged with a network, other computer systems, and/or any other devices described herein. In many embodiments, the computer system 700 will further comprise a non-transitory working memory 718, which can include a RAM or ROM device, as described above.

The computer system 700 also can comprise software elements, shown as being currently located within the working memory 718, including an operating system 714, device drivers, executable libraries, and/or other code, such as one or more application programs 716, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 706 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some embodiments, one or more elements of the computer system 700 may be omitted or may be implemented separate from the illustrated system. For example, the processor 704 and/or other elements may be implemented separate from the input device 708. In one embodiment, the processor is configured to receive images from one or more cameras that are separately implemented. In some embodiments, elements in addition to those illustrated in FIG. 7 may be included in the computer system 700.

Some embodiments may employ a computer system (such as the computer system 700) to perform methods in accordance with the disclosure. For example, some or all of the procedures of the described methods may be performed by the computer system 700 in response to processor 704 executing one or more sequences of one or more instructions (which might be incorporated into the operating system 714 and/or other code, such as an application program 716) contained in the working memory 718. Such instructions may be read into the working memory 718 from another computer-readable medium, such as one or more of the storage device(s) 706. Merely by way of example, execution of the sequences of instructions contained in the working memory 718 might cause the processor(s) 704 to perform one or more procedures of the methods described herein.

The terms “machine-readable medium” and “computer-readable medium,” as used herein, refer to any medium that participates in providing data that causes a machine to operate in a specific fashion. In some embodiments implemented using the computer system 700, various computer-readable media might be involved in providing instructions/code to processor(s) 704 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 706. Volatile media include, without limitation, dynamic memory, such as the working memory 718. Transmission media include, without limitation, coaxial cables, copper wire and fiber optics, including the wires that comprise the bus 702, as well as the various components of the communications subsystem 712 (and/or the media by which the communications subsystem 712 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 704 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 712 (and/or components thereof) generally will receive the signals, and the bus 702 then might carry the signals (and/or the data, instructions, etc. carried by the signals) to the working memory 718, from which the processor(s) 704 retrieves and executes the instructions. The instructions received by the working memory 718 may optionally be stored on a non-transitory storage device 706 either before or after execution by the processor(s) 704.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments are described as processes depicted as flow diagrams or block diagrams. Although each may describe the operations as a sequential process, many of the operations can be performed in parallel or concurrently. In addition, the order of the operations may be rearranged. A process may have additional steps not included in the figures. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Thus, in the description above, functions or methods that are described as being performed by the computer system may be performed by a processor—for example, the processor 704—configured to perform the functions or methods. Further, such functions or methods may be performed by a processor executing instructions stored on one or more computer readable media.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

Various examples have been described. These and other examples are within the scope of the following claims.

What is claimed is:

1. A method, comprising:
within a social network system comprising one or more channels of content, receiving, from a first channel, a first request to present content via a first content unit within a user interface (UI) being presented to a user;
determining whether content has been presented to the user within a predetermined window of time prior to a present time;
in response to determining that content has not been presented to the user within the predetermined window of time, determining whether a second request from a second channel to present content via a second content unit within the UI is pending, otherwise denying the received first request to present the content; and
in response to determining that the second request is not pending from the second channel to present content via the second content unit within the UI, granting the first request to present the content via the first content unit within the UI, otherwise granting either the first request or the second request based on an order of priority between the first channel and the second channel.

2. The method of claim 1, wherein the order of priority between the first channel and the second channel is determined by assigning a higher priority to the first channel if a number of previously granted requests for the first channel is less than a number of previously granted requests for the second channel, otherwise assigning a higher priority to the second channel.

3. The method of claim 1, wherein the order of priority between the first channel and the second channel is determined by comparing a priority number associated with the first channel to a priority number associated with the second channel.

4. The method of claim 1, wherein the order of priority between the first channel and the second channel is determined based on an output from a classifier, wherein the classifier is trained using data associated with prior engagements by the user with content, and wherein the classifier receives as inputs data pertaining to the user and the content.

5. The method of claim 1, further comprising:
receiving, from an urgent channel, an urgent request to present content within the UI; and
granting the received urgent request to present the content within the UI irrespective of whether content has been presented to the user within the predetermined window of time prior to the present time.

6. The method of claim 1, further comprising assigning a slot within the predetermined window of time to the first content unit.

7. The method of claim 6, further comprising:
determining whether another one of the one or more channels of content that has a higher priority than the first channel has content available to present via another content unit within the UI; and
reassigning the slot within the predetermined window of time to the other content unit.

8. The method of claim 1, further comprising determining whether the one or more channels of content have content available to present within the UI to the user.

9. The method of claim 1, further comprising:
upon an event wherein the UI being presented to the user is refreshed, receiving a request from one of the one or more channels to present content within the UI, wherein another one of the one or more channels has been presenting content within the UI prior to the UI being refreshed;
determining whether the other one of the one or more channels has been presenting content within the UI for a period of time exceeding the predetermined window of time; and
in response to determining that the other one of the one or more channels has been presenting content within the UI for a period of time exceeding the predetermined window of time, granting the request from the one of one or more channels to present content within the UI, otherwise denying the request.

10. The method of claim 1, wherein the content is system-generated content.

11. A system, comprising:
a processor; and
a non-transitory computer readable medium coupled the processor, the computer readable medium comprising code, executable by the processor, for implementing a method comprising:
within a social network system comprising one or more channels of content, receiving, from a first channel, a first request to present content via a first content unit within a user interface (UI) being presented to a user;
determining whether content has been presented to the user within a predetermined window of time prior to a present time;
in response to determining that content has not been presented to the user within the predetermined window of time, determining whether a second request from a second channel to present content via a second content unit within the UI is pending, otherwise denying the received first request to present the content; and
in response to determining that the second request is not pending from the second channel to present content via the second content unit within the UI, granting the first request to present the content via the first content unit within the UI, otherwise granting either the first request or the second request based on an order of priority between the first channel and the second channel.

12. The system of claim 11, wherein the order of priority between the first channel and the second channel is determined by assigning a higher priority to the first channel if a number of previously granted requests for the first channel is less than a number of previously granted requests for the second channel, otherwise assigning a higher priority to the second channel.

13. The system of claim 11, wherein the order of priority between the first channel and the second channel is determined by comparing a priority number associated with the first channel to a priority number associated with the second channel.

14. The system of claim 11, wherein the order of priority between the first channel and the second channel is determined based on an output from a classifier, wherein the classifier is trained using data associated with prior engagements by the user with content, and wherein the classifier receives as inputs data pertaining to the user and the content.

15. The system of claim 11, further comprising:
receiving, from an urgent channel, an urgent request to present content within the UI; and
granting the received urgent request to present the content within the UI irrespective of whether content has been presented to the user within the predetermined window of time prior to the present time.

16. The system of claim 11, further comprising assigning a slot within the predetermined window of time to the first content unit.

17. The system of claim 16, further comprising:
determining whether another one of the one or more channels of content that has a higher priority than the first channel has content available to present via another content unit within the UI; and
reassigning the slot within the predetermined window of time to the other content unit.

18. The system of claim 11, further comprising determining whether the one or more channels of content have content available to present within the UI to the user.

19. The system of claim 11, further comprising:
upon an event wherein the UI being presented to the user is refreshed, receiving a request from one of the one or more channels to present content within the UI, wherein another one of the one or more channels has been presenting content within the UI prior to the UI being refreshed;
determining whether the other one of the one or more channels has been presenting content within the UI for a period of time exceeding the predetermined window of time; and
in response to determining that the other one of the one or more channels has been presenting content within the UI for a period of time exceeding the predetermined window of time, granting the request from the one of one or more channels to present content within the UI, otherwise denying the request.

20. One or more non-transitory computer-readable media storing computer-executable instructions that, when executed, cause one or more computing devices to:
within a social network system comprising one or more channels of content, receive, from a first channel, a first request to present content via a first content unit within a user interface (UI) being presented to a user;
determine whether content has been presented to the user within a predetermined window of time prior to a present time;
in response to determining that content has not been presented to the user within the predetermined window of time, determine whether a second request from a second channel to present content via a second content unit within the UI is pending, otherwise deny the received first request to present the content; and
in response to determining that the second request is not pending from the second channel to present content via the second content unit within the UI, grant the first request to present the content via the first content unit within the UI, otherwise grant either the first request or the second request based on an order of priority between the first channel and the second channel.
